(19) United States
(12) Patent Application Publication
(10) Pub. No.: US 2025/0027829 A1
(43) Pub. Date: Jan. 23, 2025

(54) VALVE ARRANGEMENT

(71) Applicant: ZEHNDER GROUP INTERNATIONAL AG, CH-5722 GRÄNICHEN (CH)

(72) Inventors: Remco WALTA, Steenwijkerwold (NL); Hans MEIJER, Amersfoort (NL)

(73) Assignee: ZEHNDER GROUP INTERNATIONAL AG, CH-5722 GRÄNICHEN (CH)

(21) Appl. No.: 18/684,455

(22) PCT Filed: Sep. 20, 2022
(86) PCT No.: PCT/EP2022/076048

§ 371 Date: Feb. 16, 2024

(30) Foreign Application Priority Data
Sep. 24, 2021 (CH) 070304/2021

(51) Int. Cl. G01L 19/00; G01L 13/00

(52) U.S. Cl. CPC G01L 19/0007; G01L 13/00

(57) ABSTRACT

Disclosed herein is a valve arrangement (1) for controlling airflow and for determining air pressure, wherein the valve arrangement (1) comprises a pressure sensor assembly (7) being configured to determine the dynamic air pressure from a measured static air pressure and a measured total air pressure; a tubular pipe body (2) comprising a first opening (21) and a second opening (22) and defining a valve chamber (23) between the first opening and the second opening, wherein the tubular pipe body (2) defines a constriction (24) of the valve chamber (23) between the first opening (21) and the second opening (22) along a longitudinal direction (LO) of the tubular pipe body (2), wherein the tubular body (2) comprises a static pressure chamber (25) being in fluidic communication with the pressure sensor assembly, wherein the static pressure chamber (25) is configured such that the static air pressure at the constriction of the air flowing through the tubular pipe body is measured by the pressure sensor assembly; a first support element (31) and a second support element (32), wherein the first support element (31) and the second support element (32) are arranged in the valve chamber (23) between the first opening (21) and the second opening (22), wherein the first support element (31) and the second support element (32) each extend transversally through the valve chamber (24), wherein the first support element (31) and/or the second support element (32) comprises one or more air channels (33) being in fluidic communication with the pressure sensor assembly, wherein the one or more air channels are configured such that the total air pressure is measured by the pressure sensor assembly; a valve body (4) being movably arranged in the valve chamber (23), wherein the valve body (4) is configured such that the valve body (4) is movable towards the constriction (24) upon which air flow through the tubular pipe body (2) is decreased.

### BACKGROUND OF THE INVENTION

### Field of the Invention

The present invention lies in the technical field of building ventilation technology and relates in particular to a valve arrangement and a method for determining the air pressure of an air flow using such a valve arrangement.

### Discussion of Related Art

Ventilation systems generally comprise ventilation tubes which deliver and remove air to and from the inside of a building. In order to control and adjust the airflow through those tubes, valves are typically employed. Most commonly, flap valves comprising a rotatable flap are installed within a ventilation tube. Such known flap-type valves generate a high degree of turbulence in the immediate vicinity when air passes through them, especially when the valve is not in its fully open state, i.e. with the plane of the flap forming an angle between about 5° and 90° at which the valve is closed, with respect to the longitudinal axis of the pipe section or the overall air flow direction. This high degree of turbulence may be described as comprising both microturbulence with smaller-scale rotational air movement, i.e. vortices with relatively small diameters, and macroturbulence with larger-scale rotational air movement, i.e. vortices with relatively large diameters due to relatively high air speeds in a valve, microturbulence is usually always present. In contrast, macroturbulence is added to the microturbulence when the flap is in a position moved away from its open position. Both microturbulence and macroturbulence contribute to noise generation. Pressure measurements to be used for air flow determination can be performed in air flow regions with microturbulence. However, such pressure measurements, when performed in air flow regions with macroturbulence, suffer from poor accuracy and are thus not suited for determining the air flow.

Furthermore, in order to determine the air flow through a valve, the static pressure drop across a valve is often determined. This may be achieved by arranging a static flow sensor assembly having a first pressure averaging chamber upstream of the valve and a second pressure averaging chamber downstream of the valve. Due to the static pressure drop across the valve, and due to the measuring principle of such flow sensor assemblies, a flow is generated through the sensor. The sensor provides a signal which is correlated to the amount of flow going through the valve which depends on the current configuration of the valve, i.e. the current open cross-section through which air can flow.

While such pressure measurements are typically suitable for straight ventilation tubes, they can be problematic upon the occurrence of turbulences. For example, if the valve and thus also the static flow sensor assembly are installed downstream of a bend or a T-junction of a ventilation tube, the accuracy of the pressure measurement profoundly decreases.

### SUMMARY OF THE INVENTION

It is therefore the general object of the present invention to advance the state of the art of valve arrangements for ventilation systems and of pressure measurements at such valve arrangements and preferably overcome the disadvantages mentioned above fully or partially. In favorable embodiments, a valve arrangement is provided which decreases the occurrence of macroturbulences and/or noise emissions. In further favorable embodiments, a valve arrangement and a measuring method is provided which allows for a more accurate pressure and airflow determination through the valve arrangement. In further embodiments, a valve arrangement is provided that can be easily operated.

The general object is in a first aspect achieved by a valve arrangement and in a second aspect by a method for determining the air pressure of an air flow according to the independent claims. Other favorable embodiments follow from the dependent claims and the disclosures as a whole.

A first aspect of the invention relates to a valve arrangement for controlling airflow and for determining air pressure, in particular dynamic pressure. The valve arrangement comprises a pressure sensor assembly being configured to determine the dynamic air pressure from a measured static air pressure and a measured total air pressure of an airflow through the valve arrangement. Preferably, the pressure sensor assembly comprises a differential pressure sensor. Furthermore, the valve arrangement comprises a tubular pipe body. The tubular pipe body comprises a first opening and a second opening and further defines a valve chamber between the first opening and the second opening. The tubular pipe body additionally defines a constriction of this valve chamber between the first opening and the second opening along a longitudinal direction of the tubular pipe body. The tubular pipe body further comprises a static pressure chamber being fluidic connected to, i.e. being in fluid communication with, the pressure sensor assembly. The static pressure chamber is configured such that the static air pressure at the constriction of the air flowing through the tubular pipe body is measured by the pressure sensor assembly. The valve arrangement also comprises a first support element and a second support element, which are each arranged in the valve chamber between the first opening and the second opening and which each extend transversely through the valve chamber. It is understood that “transversely”, i.e. the transverse or lateral direction is perpendicular to the longitudinal direction. For example, if the valve chamber is essentially cylindrical, then the longitudinal direction refers to the cylinder height and the transverse direction to the diameter of the cylinder. The first support element and/or the second support element comprises one or more air channels being in fluidic communication with the pressure sensor assembly, wherein the one or more air channels are configured such that the total air pressure is measured by the pressure sensor assembly. In preferred embodiments only the first support element comprises such one or more air channels. It is understood that the first support element is in the operative state positioned upstream of the valve body and the air channels, e.g. the air channels of the first support element, in general face away from the valve body, i.e. towards the incoming air stream. The valve arrangement further comprises a valve body, which is movably arranged within the valve chamber. The valve body is configured such that it is movable, in particular with respect to the tubular pipe body, towards the constriction upon which air flow through the tubular pipe body is decreased, in particular prevented. It is understood that vice versa, the valve body is configured such that it is movable, in particular with respect to the tubular pipe body, away from the constriction upon which air flow through the tubular pipe body is increased. By providing a constriction at which the static pressure can be determined, the accuracy of the pressure measurement is profoundly increased. Since the cross-section at the constriction is reduced, which increases the airflow velocity, the obtained signal of the dynamic pressure is significantly improved. By way of this arrangement the dynamic pressure can directly be determined, which is a direct measure for the airflow. From this, the airflow through the valve arrangement can be obtained in a more accurate manner, even in cases in which the valve arrangement is upstream connected to a bend or a T-junction. Specifically, it has been found that compared to a known double chamber static pressure measurement, the deviation of the derived air volume values can be decreased from ±13% to ±5%.

The pressure sensor assembly may in some embodiments comprise, or consist of, a differential pressure sensor. Such a differential pressure sensor can measure the total air pressure, i.e. it is in fluid connection with one or more air channels at the first and/or second support element, and it can measure the static air pressure at the constriction of the tubular pipe body, i.e. it is in fluid communication with the static pressure chamber. From the difference between the total air pressure and the static air pressure, the dynamic air pressure is determined. Alternatively, the pressure sensor assembly may comprise a static pressure sensor being configured to measure the static pressure in the static pressure chamber and a separate total pressure sensor being configured to measure the total air pressure, e.g. via the air channels. Both, the static pressure sensor and the therefrom separate total air pressure sensor may each be configured such that a control unit of the valve arrangement, in particular the control unit described further below, receives the measured static air pressure of the static pressure sensor and the measured total pressure of the total air pressure and determines the dynamic air pressure by subtracting the static air pressure from the total air pressure.

The longitudinal direction of the tubular pipe body may refer to the direction of airflow through the valve arrangement, i.e. it may typically be parallel to the air flow through the valve arrangement. A constriction as used herein refers to a structure with a reduced cross-section as compared to another, or in particular any other, position of the valve chamber. Preferably, along the longitudinal direction, the cross-section of the valve chamber is larger upstream and downstream of the constriction as compared to the cross-section at the constriction.

The first support element and the second support element extend transversely through the valve chamber, i.e. they cross the valve chamber essentially perpendicular to the direction of airflow. Therefore, the first support element and the second support element may be configured such that air entering or exiting the valve chamber is guided towards the first or second support element in an essentially perpendicular manner. It is further understood that the terms “first” and “second” as used herein refer to two separated and thus different elements which may for example be arranged at different locations, unless noted otherwise. Furthermore, the skilled person understands that a pressure sensor assembly as used herein contains at least one pressure sensor, in particular a differential pressure sensor.

Typically, the valve body is arranged such within the valve chamber that air flowing through the tubular pipe body flows around the valve body, in particular such that it circumferentially surrounds the valve body. For example, the valve body may be arranged such within the valve chamber that a circumferential gap is formed between the tubular pipe body, respectively its inner wall, and the valve body. In general, the tubular pipe body may comprise an inner wall. This inner wall is defining the valve chamber.

In some embodiments, the valve body is unmovable in the lateral direction, i.e. to the direction being perpendicular to the longitudinal direction of the tubular pipe body.

Typically, the first opening and the second opening are directly opposing each other, i.e. they are arranged at opposite ends of the tubular pipe body. In some embodiments, they may be coaxially arranged with respect to each other, respectively may not be offset in the lateral direction to each other.

In some embodiments, the valve arrangement further comprises a guide element, particularly a guide rail, being attached, respectively mounted, to the first support element and the second support element and extending along the longitudinal direction of the tubular pipe body, i.e. between the first support element and the second support element. The valve body is movably supported by the guide element, particularly along the longitudinal direction of the tubular pipe body. In some embodiments, the guide element may protrude the valve body. The guide element typically extends along the longitudinal direction of the tubular pipe body.

In some embodiments, the valve arrangement further comprises a drive element, in particular a motor, being configured for moving the valve body relative to the tubular pipe body, in particular along the longitudinal direction of the tubular pipe body, and particularly relative to the guide element. For example, the drive element may be adapted to interact with the guide element. In preferred embodiments, the drive element is attached to or integral part of the valve body. In certain embodiments, the drive element may comprise a pinion drive and the guide element may comprise a rack; or the drive element may comprise a worm wheel and the guide element may be or comprise a worm screw.

In some embodiments, the static pressure chamber is in fluid communication with the valve chamber via slots at the constriction. Preferably, the slots are radially circumferentially arranged at the constriction. The fact that the slots are arranged at the constriction means that they typically comprise openings into the valve chamber at the smallest cross-section of the valve chamber. The slots may be radially and circumferentially arranged around an inner wall of the tubular pipe body defining the valve chamber. As the slots are in direct fluid communication with the static pressure chamber, it is possible to measure the static pressure directly at the smallest cross-section, which improves the obtained signal and thus the accuracy of the measurement. In some embodiments, the static pressure chamber may be arranged upstream of the slots.

In certain embodiments, the air channels each comprise an air channel opening facing away from the valve body along the longitudinal direction of the tubular pipe body.

In some embodiments, the valve arrangement comprises only a single constriction, i.e. between the first opening and the second opening along the longitudinal direction there is only a single constriction of the valve chamber.

In some embodiments, the tubular pipe body is made of a polymer material. Preferably, the tubular pipe body is injection molded.

In some embodiments, the valve arrangement further comprises a control unit. The control unit may for example comprise a circuit, e.g. a microprocessor.

The control unit may for example be configured to receive a signal from the pressure sensor assembly, in particular of the differential pressure sensor, which is a measure for, respectively indicates, the dynamic pressure. Furthermore, in certain embodiments, the control unit may be configured to control the drive unit. For example, the control unit may be configured for adjusting the position of the valve body along the longitudinal direction of the tubular pipe body with respect to the tubular pipe body, particularly with respect to the constriction. Such an adjustment may occur automatically depending on the determined pressures, e.g. the dynamic pressure, or the determined airflow.

In some embodiments, the first support element and the second support element each comprise support rods extending transversely at least partially, or fully, through the valve chamber. In particular, the first support element and the second support element each form a cross structure. For example, the cross structure may comprise four support rods which extend from a common point of origin towards the inner wall of the tubular pipe body. Preferably, these support rods comprise the one or more air channels.

In some embodiments, the constriction defines a constriction cross-section which is smaller than the cross-section at another, in particular at any other, position of the tubular pipe body, respectively the valve chamber, along its longitudinal direction.

In some embodiments, the valve body has a shape defining a cross-section at at least one position of the valve body which is larger than the constriction cross-section. This ensures that airflow through the valve arrangement can be completely prevented if the valve body contacts the constriction. It is understood that this cross-section refers to a cross-section along the lateral direction, i.e. a plane being perpendicular to the longitudinal direction. Thus, the valve body is configured such that it cannot completely cross the constriction. However, in some embodiments it is possible that the valve body partially crosses the constriction.

In certain embodiments, the constriction comprises in cross-section along the longitudinal direction of the tubular pipe body a first inclination extending along the longitudinal direction of the tubular pipe body towards a point at which the constriction cross-section reaches its minimum and optionally a second inclination extending along the longitudinal direction from the point at which the constriction cross-section reaches its minimum thereby widening, particularly continuously widening, the cross-section of the tubular pipe body, respectively the valve chamber, as compared to the constriction cross-section. In other words, between the first opening and the second opening the cross-section of the valve chamber first decreases, in particular continuously, along the longitudinal direction of the tubular pipe body, until it reaches a minimum at the constriction, and then increases, particular continuously, again.

In some embodiments, the constriction defines a bell-shaped curve in cross-section along the longitudinal direction of the tubular pipe body. Additionally, or alternatively, the constriction comprises in cross-section along the longitudinal direction of the tubular pipe body a first point of inflexion and a second point of inflexion, which decreases the occurrence of turbulences.

In some embodiments, the constriction is at least partially formed by a jet. In certain embodiments, the jet may contain, respectively define, the slots for providing the fluid communication of the valve chamber with the static pressure chamber. Typically, the jet may at least partially define the static pressure chamber. For example, the static pressure chamber may be defined by, respectively formed between, the jet and an inner wall of the tubular pipe body. The jet may be structurally separate from the tubular pipe body.

The jet may in some examples be arranged between the first opening and the constriction, e.g. the constriction cross-section, which is typically the minimum cross-section of the valve chamber.

In some embodiments, the valve body comprises or consists of a base body which preferably has the shape of an ovoid, in particular of an asymmetric ovoid. An asymmetric ovoid is an ovoid whose largest cross-section is not in the center, but shifted along its longitudinal axis towards one end of the ovoid. Preferably, the largest cross-section of the base body is along the longitudinal direction arranged closer to the constriction than the center of the base body. Such a shape has the advantage that turbulences are diminished and high airflow control is achieved.

In some embodiments, the valve body comprises one or more fins protruding from the base body and wherein the tubular pipe body defines one or more fin accommodation structures which each are configured to accommodate, and optionally engage, with a fin of the valve body. The fins typically protrude towards the inner wall of the tubular pipe body. Such fins have the advantage that the valve body is stabilized not only along the longitudinal direction, but also radially, and that the accommodation structures may provide a stopper for the valve body along the longitudinal direction. The fin accommodation structures may for example comprise grooves defined by the tubular pipe body or by a separate fin accommodation structure.

In some embodiments, the ratio between the largest cross-section of the valve chamber and the constriction cross-section is between 1:0.4 to 1:0.9, in particular between 1:0.6 to 1:0.8.

The constriction cross-section may in some embodiments be between 5000 mm² to 20000 mm², in particular between 10000 mm² to 15000 mm².

Typically, the valve chamber may have a round, in particular a circular, cross-section.

The invention further relates to a ventilation unit comprising a valve arrangement according to any of the embodiments described herein and a first ventilation tube being connected to the first opening of the tubular pipe body and a second ventilation tube being connected to the second opening of the tubular pipe body.

In a second aspect, the invention relates to a method for determining the air pressure of an air flow, in particular the dynamic air pressure of an air flow comprising the steps of
Providing a valve arrangement according to any of the embodiments as described herein;
Measuring the static pressure of the air flow at the constriction, i.e. the air flow flowing through the valve arrangement, with the pressure sensor assembly; and
Measuring the total air pressure of the air flow, i.e. the air flow flowing through the valve arrangement, with the pressure sensor assembly.

In certain embodiments, the method may further comprise the determination of the dynamic pressure by the difference between the measured total air pressure and the measured static pressure, e.g. by subtracting the measured static pressure from the measured total air pressure. In some embodiments, the determination may be a computer-implemented step, particularly, the determination may be performed by the control unit, or it may be performed directly by a differential pressure sensor.

In some embodiments, the method may further comprise the determination of the air flow through the valve arrangement based on the position of the valve body with respect to the tubular pipe body and the determined/measured pressures, in particular based on the dynamic pressure. In some embodiments, the determination of the air flow may be a computer-implemented step. Particularly, the determination may be performed by the control unit.

A third aspect of the invention relates to a use of a valve arrangement according to any of the embodiments as described herein for determining the air pressure of an airflow, in particular the dynamic air pressure.

### BRIEF DESCRIPTION OF SEVERAL VIEWS OF THE DRAWINGS

The herein described invention will be more fully understood from the detailed description given herein below and the accompanying drawings which should not be considered limiting to the invention described in the appended claims. The drawings are showing:

FIG. 1 shows a perspective view of a valve arrangement according to an embodiment of the invention;

Fig, 2 shows a section view of a valve arrangement of FIG. 1;

FIG. 3 shows a frontal side view onto the valve arrangement of FIG. 1; and

FIG. 4 shows a front view of the valve arrangement of FIG. 1, in which the tubular pipe body is removed.

### DETAILED DESCRIPTION OF THE INVENTION

FIG. 1 shows a perspective view of a valve arrangement 1 according to the invention. The tubular pipe body 2 comprises second opening 22 which is directly oppositely arranged to the corresponding first opening. Furthermore, second support element 32 is visible, which extends transversely through the valve chamber defined by the tubular pipe body 2.

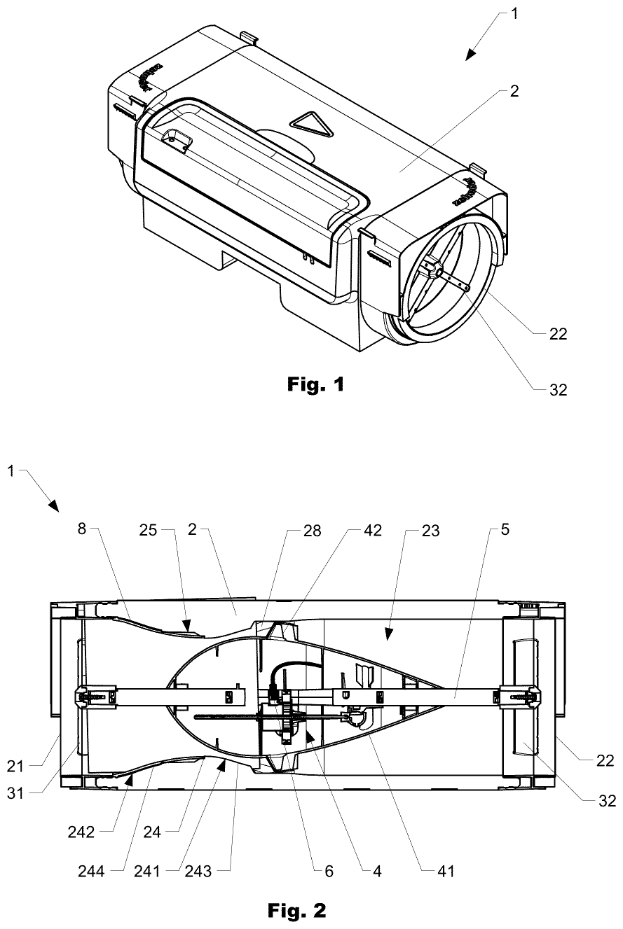

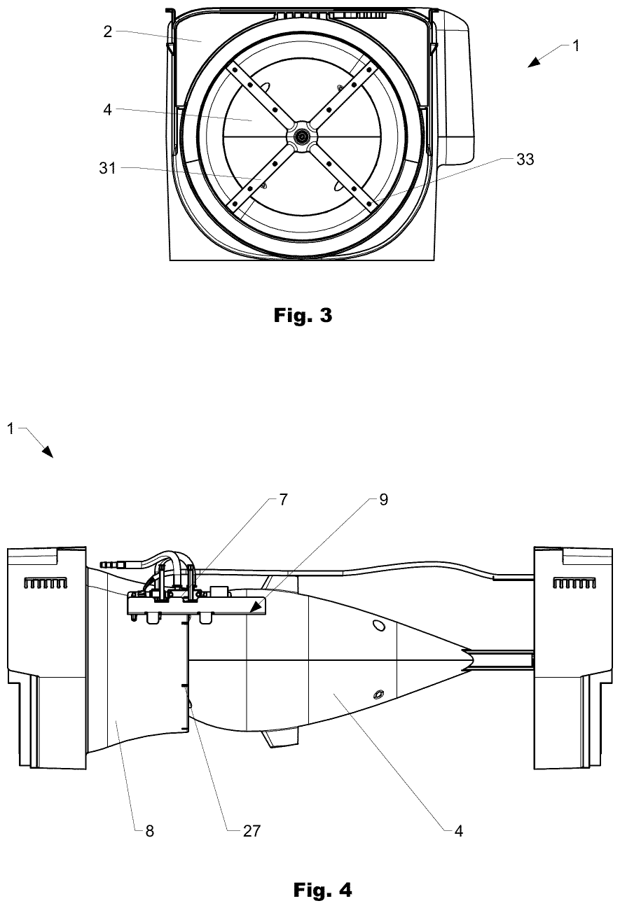

FIG. 2 shows a sectional view of the embodiment shown in FIG. 1, wherein the section runs along the longitudinal direction LO of tubular pipe body 2. Perpendicularly arranged to the longitudinal direction is the lateral or transverse direction LA. FIG. 2 shows valve arrangement 1 comprising tubular pipe body 2, first support element 31, second support element 32 and valve body 4. Tubular pipe body 2 comprises first opening 21 and second opening 22, which are generally arranged at the longitudinal end portions of the valve arrangement 1. Tubular pipe body 2 defines valve chamber 23 and further also constriction 24, which has a first inclination 241 and a second inclination 242. In the embodiment shown, constriction 24 is partially formed by jet 8. As can be seen, along the longitudinal direction LO, the cross-section of the valve chamber first decreases at the first inclination 241 until it reaches a minimum and then increases again at the second inclination 242. Tubular pipe body 2 further contains a pressure sensor assembly (not shown, see FIG. 4), which is configured to determine the dynamic air pressure from a measured static air pressure at constriction 24 and a measured total air pressure. The pressure sensor assembly is in fluid communication with static pressure chamber 25. In general, static pressure chamber 25 may circumferentially surround valve chamber 23. Static pressure chamber 25 is in fluid communication with valve chamber 23 via slots 27 (not shown in FIG. 2, see FIG. 4). Typically, the slots 27 and static pressure chamber 25 can generally be arranged such that air is not directed directly onto the pressure sensor assembly.

The valve arrangement 1 shown in FIG. 2 further comprises first support element 31 and second support element 32, which are each arranged within valve chamber 23 between the first opening 21 and the second opening 22. Both support elements each extend transversely, i.e. in the transverse or lateral direction LA, through valve chamber 24. First support element 31 further comprises, one or more air channels 33 (see FIG. 3) being in fluidic communication with the pressure sensor assembly. The one or more air channels are configured such that the total air pressure is measured by the pressure sensor assembly.

Valve arrangement 1 further comprises valve body 4, which is arranged inside valve chamber 23. Valve body 4 is configured, respectively arranged, such that it is movable towards (and therefore also away from) constriction 24 along the longitudinal direction LO of tubular pipe body 2. Valve body 4 comprises base body 41 which is ovoid shaped. In the embodiment shown base body 41 has an asymmetric ovoid shape, as the largest cross section is not at the center of base body, but arranged closer to the constriction than the center along the longitudinal extension of base body 41. Valve body 4 further comprises fins 42 (only one fin is referenced for clarity purposes) which protrude in the lateral, respectively transversal, direction towards an inner wall of the tubular pipe body 2. Tubular pipe body 2 comprises fin accommodation structures 28 (only one structure is referenced for clarity reasons), which are configured to accommodate and optionally engage with the corresponding fin when valve body 4 is moved towards constriction 24. Valve body 4 can be moved along guide element 5 in the longitudinal direction towards and away from constriction 24. This can be achieved by drive element 6.

FIG. 3 shows a view onto first support element 31, i.e. also onto the first opening of tubular pipe body 2. As can be seen, the first support structure 31 is a cross structure comprising four support rods, which extend from a common origin in the transverse, respectively lateral, direction towards an inner wall of tubular pipe body 2. Behind first support structure 31 is valve body 4. First support structure 31 comprises channels 33 which are in fluidic communication with the pressure sensor assembly.

FIG. 4 shows a view of the valve arrangement of FIG. 1, in which for clarity purposes, parts of the tubular pipe body are not shown. Static pressure chamber 25 (not referenced, see FIG. 2) is in fluid communication with valve chamber 23 via slots 27. Typically, the slots 27 and static pressure chamber 25 can generally be arranged such that air is not directed directly onto the pressure sensor assembly. Slots 27 circumferentially surround valve chamber 23 at the constriction, i.e. at the position at which the valve chamber has the minimum cross-section (i.e. the “constriction cross-section”). Therefore, the slots are circumferentially radially arranged at the constriction. In the embodiment shown, constriction 24 is partially formed by jet 8, which also defines slots 27 in this embodiment. In this figure, the pressure sensor assembly 7 can be seen, which in this case is a differential pressure sensor and which is configured to measure the static pressure at the constriction and the total air pressure of the airflow through the valve arrangement and further to determine the dynamic pressure from the measured static air pressure and total air pressure. Furthermore, in the embodiment shown, the valve arrangement comprises control unit 9. The control unit 9 may be configured to receive a signal from the pressure sensor assembly 7, which can be a measure for the dynamic air pressure. Furthermore, it is in this embodiment or any other embodiment described herein, possible that the control unit is configured for adjusting the position of valve body 4, e.g. via the drive element, upon determining an air pressure, for example the dynamic pressure, or the airflow through the valve arrangement and upon determining that a corresponding predefined threshold value has been exceeded or undercut.

1. A valve arrangement (1) for controlling airflow and for determining air pressure, wherein the valve arrangement (1) comprises:
a. a pressure sensor assembly (7) configured to determine the dynamic air pressure from a measured static air pressure and a measured total air pressure;
b. a tubular pipe body (2) comprising a first opening (21) and a second opening (22) and defining a valve chamber (23) between the first opening and the second opening, wherein the tubular pipe body (2) defines a constriction (24) of the valve chamber (23) between the first opening (21) and the second opening (22) along a longitudinal direction (LO) of the tubular pipe body (2), wherein the tubular body (2) comprises a static pressure chamber (25) in fluidic communication with the pressure sensor assembly, wherein the static pressure chamber (25) is configured such that the static air pressure at the constriction of the air flowing through the tubular pipe body is measured by the pressure sensor assembly;
c. a first support element (31) and a second support element (32), wherein the first support element (31) and the second support element (32) are arranged in the valve chamber (23) between the first opening (21) and the second opening (22), wherein the first support element (31) and the second support element (32) each extend transversely through the valve chamber (24), wherein the first support element (31) and/or the second support element (32) comprises one or more air channels (33) being in fluidic communication with the pressure sensor assembly, wherein the one or more air channels are configured such that the total air pressure is measured by the pressure sensor assembly; and
d. a valve body (4) being movably arranged in the valve chamber (23), wherein the valve body (4) is configured such that the valve body (4) is movable towards the constriction (24) upon which air flow through the tubular pipe body (2) is decreased.

2. The valve arrangement (1) according to claim 1, further comprising at least one of a guide element (5) and a guide rail being mounted to the first support element (31) and the second support element (32) and extending along the longitudinal direction (LO) of the tubular pipe body (2), wherein the valve body (4) is movably supported by the at least one of the guide element (5) and the guide rail, along the longitudinal direction (LO) of the tubular pipe body (2).

3. The valve arrangement (1) according to claim 1, further comprising at least one of a drive element (6) and a motor configured for moving the valve body (4) relative to the tubular pipe body (2), along the longitudinal direction (LO) of the tubular pipe body (2).

4. The valve arrangement (1) according to claim 1, wherein the static pressure chamber (25) is in fluid communication with the valve chamber (23) via slots (27) at the constriction (24), wherein the slots (27) are radially circumferentially arranged at the constriction (24).

5. The valve arrangement (1) according to claim 1, wherein the air channels (33) each comprise an air channel opening facing away from the valve body (4) along the longitudinal direction (LO) of the tubular pipe body (2).

6. The valve arrangement (1) according to claim 1, further comprising a control unit (9), wherein the control unit (9) is configured to receive a signal from the pressure sensor assembly (7) as a measure for the dynamic air pressure.

7. The valve arrangement (1) according to claim 1, wherein the first support element (31) and the second support element (32) each comprise support rods extending transversely through the valve chamber (23), wherein the first support element (31) and/or the second support element (32) each form a cross structure.

8. The valve arrangement (1) according to claim 1, wherein the constriction (24) defines a constriction cross-section which is smaller than a cross-section of the valve chamber (23) at another, in particular at any other, position of the tubular pipe body (2) along its longitudinal direction (LO).

9. The valve arrangement (1) according to claim 8, wherein the valve body (4) has a shape defining a cross-section at at least one position of the valve body (4) which is larger than the constriction cross-section.

10. The valve arrangement (1) according to claim 1, wherein the valve body (4) comprises a base body (41) which has the shape of an ovoid or an asymmetric ovoid.

11. The valve arrangement (1) according to claim 10, wherein the valve body (4) comprises one or more fins (42) protruding from the base body (41) and wherein the tubular pipe body (2) defines one or more fin accommodation structures (28) which each are configured to accommodate, and engage, with a fin (42) of the valve body (4).

12. A ventilation unit comprising a valve arrangement (1) according to claim 1 and a first ventilation tube being connected to the first opening (21) of the tubular pipe body (2) and a second ventilation tube being connected to the second opening (22) of the tubular pipe body (2).

13. A method for determining the air pressure of an air flow, in particular the dynamic air pressure of an air flow, comprising:
providing a valve arrangement (1) according to claim 1;
measuring the static pressure of the air flow at the constriction with the pressure sensor assembly (7);
measuring the total air pressure of the air flow with the pressure sensor assembly (7).

14. The method according to claim 13, wherein the dynamic air pressure is determined by a difference between the measured total air pressure and the measured static pressure.
